(19) United States
(12) Patent Application Publication
(10) Pub. No.: US 2019/0379653 A1
(43) Pub. Date: Dec. 12, 2019

(54) ACCELERATED COMMUNICATION ATTACK DETECTION

(71) Applicant: TITANIUM CRYPT, INC., Burlingame, CA (US)

(72) Inventor: Craig MEAD, Burlingame, CA (US)

(73) Assignee: TITANIUM CRYPT, INC., Burlingame, CA (US)

(21) Appl. No.: 16/529,848

(22) Filed: Aug. 2, 2019

Related U.S. Application Data
(63) Continuation-in-part of application No. 15/644,097, filed on Jul. 7, 2017.
Application No. 15/644,097 is a continuation of application No. 14/247,514, filed on Apr. 8, 2014, now Pat. No. 9,736,147.
(60) Provisional application No. 62/713,825, filed on Aug. 2, 2018.
(60) Provisional application No. 61/853,551, filed on Apr. 8, 2013.

(51) Int. Cl. H04L 29/06

(52) U.S. Cl. CPC H04L 63/083; H04L 63/0838; H04L 63/0428; H04L 63/1466

(57) ABSTRACT

A method for detecting an attack on a communications channel, while authenticating a user of a client device at a server or peer-to-peer or multi-peer connection is provided. The method includes: monitoring the line latency, as detected by a rapid-fire exchange of a nominal number of bytes and comparing the round trip reply latency to expected values, forming keys created by collecting information regarding the hardware, software, connection speed, or network information related to the client device or biometric information related to the user, encrypting data, using a computer microprocessor associated with the client device, with the subset of characters of the username or password, one-time-use password, or collected information, transmitting the encrypted data from the client device to the server via a network link therebetween, and decrypting the data, at the server, using a server-side copy of the username, password, and collected information.

### CROSS-REFERENCE TO RELATED APPLICATION(S)

This application claims the benefit of and priority to U.S. Provisional Patent Application No. 62/713,825, filed on Aug. 2, 2019; and to U.S. patent application Ser. No. 15/644,097, filed on Jul. 7, 2017, which claims priority to U.S. patent application Ser. No. 14/247,514, filed on Apr. 8, 2014 (now U.S. Pat. No. 9,736,147), which claims priority to U.S. Provisional Patent Application No. 61/853,551, filed on Apr. 8, 2013; the entirety of each of which is hereby incorporated by reference.

### BACKGROUND

### 1. Technical Field

The present disclosure relates to computer security and, more particularly, to any electronic communication that benefits from both rapid response through accelerated attack detection and encryption, while enhancing the system's ability to quickly detect and respond to attacks.

### 2. Discussion of the Related Art

Public/private key cryptography is in widespread use throughout the Internet and the World Wide Web and is relied on to prevent hackers, thieves, or other malicious individuals, parties, or governments from intercepting and decrypting personal, private, or otherwise sensitive information. Increasingly, however, these malicious parties are able to overcome and/or circumvent standard public/private key cryptography. At its core, this kind of cryptography relies on its complexity for its security; the system relies on the fact that malicious third parties will not have access to computers powerful enough to, for example, find primes of large numbers in real time (or in near-real time) and thereby crack the encryption with a brute-force attack. As computers become more powerful, however, and new types of computers (especially quantum computers) become more readily realizable, this assumption becomes less and less valid.

In addition to brute-force attacks, hackers have become adept at undermining, circumventing, or weakening standard public/private key cryptography such that a brute-force attack is not required or necessary. For example, malware surreptitiously installed on a client computer may log a user's keystrokes and a script injection attack can acquire credentials as a user is typing them in or modify the script completely so https or any other secure protocol is completely disabled, and thereafter credentials are transmitted via plaintext completely unknown to the user. Typically, once credentials are acquired by a third party intending to sign in, no brute-force attack on the user's encryption method is required. Similarly, a phishing attempt (via a web page, email, or malware application) may acquire the user's log-in name and password directly. Existing public/private key cryptography utilizes a trusted signing authority; a malicious third party may corrupt and/or stand in the place of this trusted signer and thereby weaken the strength of or eliminate the user's encryption (even if the user is presented with a warning that the signing authority is not recognized, the user may click through anyway). Finally, the public/private key encryption algorithms themselves may be attacked and weakened by a third party, the government or even the designer, for example, coercing a business or service to use weaker encryption algorithms and/or to generate weak random numbers (i.e., numbers that purport to be random but exhibit some pattern or history known to the malicious third party), and the best performing, most popular encryption algorithms today, Blowfish and Advanced Encryption Standard (AES), have a built-in key size limitation weakness, degrading their ability to stand the test of time and eventually rendering them useless as computing power continues to improve.

In addition to the Provisional Patent Application No. 61/853,551 and U.S. Pat. No. 9,736,147, which addressed both stronger encryption and attack detection techniques ranging from thwarting key stroke loggers utilizing a Quantum Computing technique, to detecting man-in-the-middle attacks utilizing communication latency tests, embodiments of the present disclosure strengthen the man-in-the-middle (MITM) attack detection while simultaneously providing encryption services, thereby reducing or minimizing the impact of man-in-the-middle attack detection on the encryption process improving overall system performance, even if attached devices lack CPU power, or corrosion or other interference is present in the transmission path. While already proven functional in multiple products developed by the inventor, unlike AES, which is known for high speed encryption, the artificial intelligence encryption model (AIEM) with device authorization and attack detection (DAAAD) (“AIEM-DAAAD”) algorithms intentionally add timed work load calculations to the encryption process as part of the MITM detection algorithms, and therefore, by design, thwarts the ability of the system to encrypt and transmit data quickly enough to serve in a Voice Over Internet Protocol (VOIP) application or other high-speed, high-bandwidth communications, i.e., video chat or high-speed trading, unless the MITM detection library is omitted from the process. The ACAD system does not rely on workloads to detect MITM attacks; rather any delay caused by inserting a third-party in the active exchange causes unexpected latency, and when an unauthorized party attempts to forge time stamps, the Merkle-tree blockchain becomes corrupt, thereby immediately invalidating keys used to decrypt transmissions.

For any or all of these reasons, a need therefore exists for a system and method for securely (a) creating a key that is unbreakable by either a brute-force attack of one or more computers, or as computer CPU capacity improves, able to stand the test of time, (b) definitively establishing a connection between entities on a computer network, (c) detecting the presence of malware or an unauthorized participant to the transmissions, and d) transmitting sensitive information in an un-hackable format therebetween, (e) monitoring the session and client state by the server, so when an attack is detected an unaware, inattentive or negligent user cannot simply by-pass warning messages and log into a corrupt session, (f) allowing for key size and encryption strength to grow in size automatically to compensate for faster computers able of attack ciphers with brute force, and (g) performing these functions at a speed that allows the system to function in high-speed, high-volume traffic such as VOIP and live streaming video.

### SUMMARY

Accordingly, the present disclosure is directed to accelerated communication attack detection that substantially obviates one or more of the issues due to limitations and disadvantages of the related art.

Additional features and aspects will be set forth in the description that follows, and in part will be apparent from the description, or may be learned by practice of the inventive concepts provided herein. Other features and aspects of the inventive concepts may be realized and attained by the structure particularly pointed out in the written description, or derivable therefrom, and the claims hereof as well as the appended drawings.

In general, various aspects of the systems and methods described herein permit a user of a software or firmware application, browser, cell phone, or other electronic mechanism (hereinafter “client” or “first party”) to create various sets of digitized fingerprints (hereinafter “fingerprints”), which may be divided into static fingerprints that are generally the same each time a user accesses a server, dedicated system, firmware driven device, peer-to-peer client or phone, or multi-peer network (hereinafter “second parties”), together forming a group of authorized parties, and dynamic fingerprints which may vary either slightly or widely from session to session, including device hardware and software performance and capabilities, user behavior, user bio-metric performance and physical characteristics (such as retina or facial scanning, hand, cardiac pulse, physical fingerprint(s) or other optional biological characteristics), CPU processes, loads and capacities and transmission characteristics shared among the authorized parties, page format, content, byte count and page load speeds, as well as an optional temporary key used for two-factor authentication (hereinafter “2FA”) which may or may not rely on a secondary device, person or process.

Other embodiments of the present disclosure permit the authorized parties to strengthen their respective fingerprints based on transmission statistics including, but not limited to IP address, one-way and round-trip packet latency times and hashes derived from transmission content and clock offsets between the authorized parties and to use the fingerprints to form a set of semi-unique credentials further refined by the user's ID, password, challenge questions, images or other data known to the user, and optional 2FA. The credentials may be transmitted via the network to one or more authorized parties, which are then utilized to authenticate the client, and used by the client to authenticate any other authorized parties. A primitive level of encryption may be created during the initial authentication process sufficient to exclude revealing sensitive information in real-time, without exposing any sensitive information that could be obtained from an offline brute-force attack, in which the transmitted data can only be created and later verified to be a valid client demonstrating “no man-in-the-middle Attack” is present, thereby allowing a key exchange, in one embodiment of the present disclosure utilizing a standard Diffie-Hellman to complete without a Spoiler attack. In embodiments of the present disclosure in which the AIEM-DAAAD Quantum Computing and one time pad methodologies are utilized, the authentication process can also defeat keystroke loggers, phishing and over-the-shoulder attacks by recognizing a user without the user typing in their full username or full password.

A full level of encryption may thereafter be established, which may grow stronger as CPU speeds continue to improve, sufficient to avoid or prevent any attack either during the session or at a later date during the lifetime of the user, despite possibilities of advances in CPUs which might allow a brute force attack on a weaker algorithm, again without the user typing in their full username. A unique, random set of shared keys known only to the authenticated parties may thereafter be established, without transmitting the username, password or keys during the login process; and thereafter, the shared keys may be used to encrypt data which may be decrypted only by the authenticated parties, but cannot be decrypted by either an active man-in-the-middle attacker attempting to modify or control the session, or a passive man-in-the-middle attacker who simply records the session for an attempt to decrypt the data later. Nor can a user who lacks all the credentials or challenge questions required for verification establish a valid session with authorized parties with a username, one-time password, or any device, bio-metric or other credentials. Nor can an attacker perform a replay attack to either decrypt the session data and thereupon log into or otherwise obtain data which would allow an attacker to compromise an account (hereinafter “sensitive data”); nor can a man-in-the-middle attacker modify the user's scripts with an intent of tricking a user into providing credentials to be utilized by the attacker in the same or subsequent session.

To enhance MITM attack detection, rather than relying on latency analysis amplified by a math-based work load, which adds time delays making the system unsuitable for VOIP applications, the ACAD systems continues to monitor the line latency with a high frequency, instantaneous cross-talk consisting of a small time stamp packet of data based on a Merkle tree blockchain derived from the time stamp data. On receipt, the receiver, whether a peer or a server, immediately replies with a similar tiny packet which incorporates a similar time stamp. The process repeats throughout the conversation, thereby testing line latency for any anomalies which might indicate a change of state in the number of passive (listening), or active (corrupting) parties. In this way, key exchanges, such as the Diffie-Hellman algorithm, can be accomplished on a transmission path with a clean signal without becoming defective through an MITM Oracle, or Spoiler attack where a MITM attack pretends to be a Server to a Client and a Client to a Server, intercepting and creating keys for multiple parties.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with embodiments of the disclosure. It is to be understood that both the foregoing general description and the following detailed description of the present disclosure are examples and explanatory, and are intended to provide further explanation of the disclosure as claimed.

### BRIEF DESCRIPTION OF THE DRAWINGS

The accompanying drawings, that may be included to provide a further understanding of the disclosure and are incorporated in and constitute a part of this specification, illustrate embodiments of the disclosure and together with the description serve to explain various principles of the disclosure.

FIG. 1 illustrates a network environment containing example network connections in accordance with an embodiment of the present disclosure.

FIG. 2 illustrates a network environment containing example malicious third-party attackers in accordance with an embodiment of the present disclosure.

FIG. 3 illustrates an example client system in accordance with an embodiment of the present disclosure.

FIG. 4 illustrates an example server system in accordance with an embodiment of the present disclosure.

FIG. 5 illustrates two simultaneous communication channels, the rapid MITM latency test, and a normal communication channel in accordance with an embodiment of the present disclosure.

FIG. 6 illustrates two simultaneous communication channels, the rapid MITM latency test, and an abnormal communication channel with an unauthorized party inserted in the channel in accordance with an embodiment of the present disclosure.

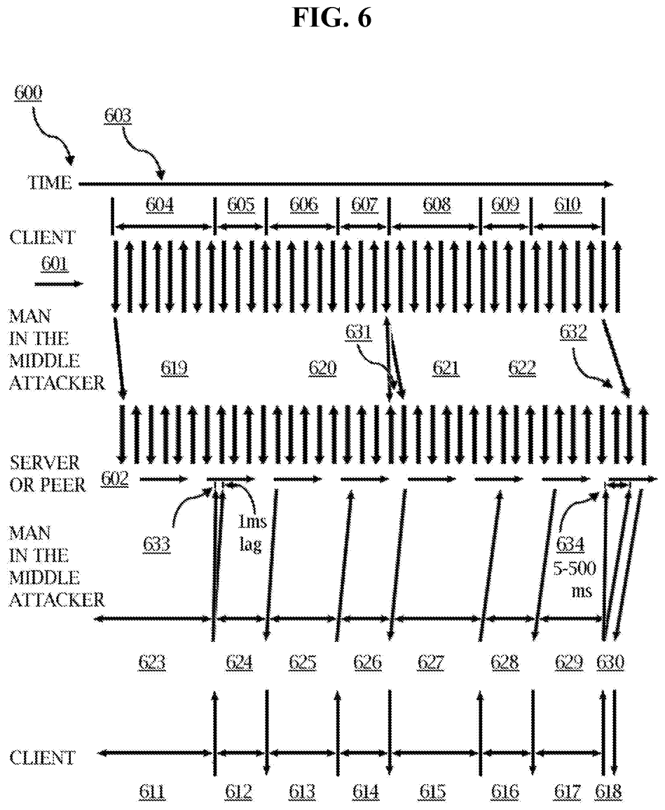

FIG. 7 illustrates a simplified log-in flow chart in accordance with an embodiment of the present disclosure.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

Reference will now be made in detail to embodiments of the present disclosure, examples of which may be illustrated in the accompanying drawings. In the following description, when a detailed description of well-known functions or configurations related to this document is determined to unnecessarily cloud a gist of the inventive concept, the detailed description thereof will be omitted. The progression of processing steps and/or operations described is an example; however, the sequence of steps and/or operations is not limited to that set forth herein and may be changed as is known in the art, with the exception of steps and/or operations necessarily occurring in a particular order. Like reference numerals designate like elements throughout. Names of the respective elements used in the following explanations are selected only for convenience of writing the specification and may be thus different from those used in actual products.

Advantages and features of the present disclosure, and implementation methods thereof will be clarified through following example embodiments described with reference to the accompanying drawings. The present disclosure may, however, be embodied in different forms and should not be construed as limited to the example embodiments set forth herein. Rather, these example embodiments are provided so that this disclosure may be sufficiently thorough and complete to assist those skilled in the art to fully understand the scope of the present disclosure. Further, the present disclosure is only defined by scopes of claims.

A shape, a size, a ratio, an angle, and a number disclosed in the drawings for describing embodiments of the present disclosure are merely an example. Thus, the present disclosure is not limited to the illustrated details. Like reference numerals refer to like elements throughout. In the following description, when the detailed description of the relevant known function or configuration is determined to unnecessarily obscure an important point of the present disclosure, the detailed description of such known function or configuration may be omitted. In a case where terms “comprise,” “have,” and “include” described in the present specification are used, another part may be added unless a more limiting term, such as “only,” is used. The terms of a singular form may include plural forms unless referred to the contrary.

In construing an element, the element is construed as including an error or tolerance range even where no explicit description of such an error or tolerance range. In describing a position relationship, when a position relation between two parts is described as, for example, “on,” “over,” “under,” or “next,” one or more other parts may be disposed between the two parts unless a more limiting term, such as “just” or “direct(ly),” is used.

In describing a time relationship, when the temporal order is described as, for example, “after,” “subsequent,” “next,” or “before,” a case which is not continuous may be included unless a more limiting term, such as “just,” “immediate(ly),” or “direct(ly),” is used.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

In describing elements of the present disclosure, the terms like “first,” “second,” “A,” “B,” “(a),” and “(b)” may be used. These terms are merely for differentiating one element from another element, and the essence, sequence, order, or number of a corresponding element should not be limited by the terms. Also, when an element or layer is described as being “connected,” “coupled,” or “adhered” to another element or layer, the element or layer can not only be directly connected or adhered to that other element or layer, but also be indirectly connected or adhered to the other element or layer with one or more intervening elements or layers “disposed” between the elements or layers, unless otherwise specified.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item.

In the description of embodiments, when a structure is described as being positioned “on or above” or “under or below” another structure, this description should be construed as including a case in which the structures contact each other as well as a case in which a third structure is disposed therebetween. The size and thickness of each element shown in the drawings are given merely for the convenience of description, and embodiments of the present disclosure are not limited thereto.

Features of various embodiments of the present disclosure may be partially or overall coupled to or combined with each other, and may be variously inter-operated with each other and driven technically as those skilled in the art can sufficiently understand. Embodiments of the present disclosure may be carried out independently from each other, or may be carried out together in co-dependent relationship.

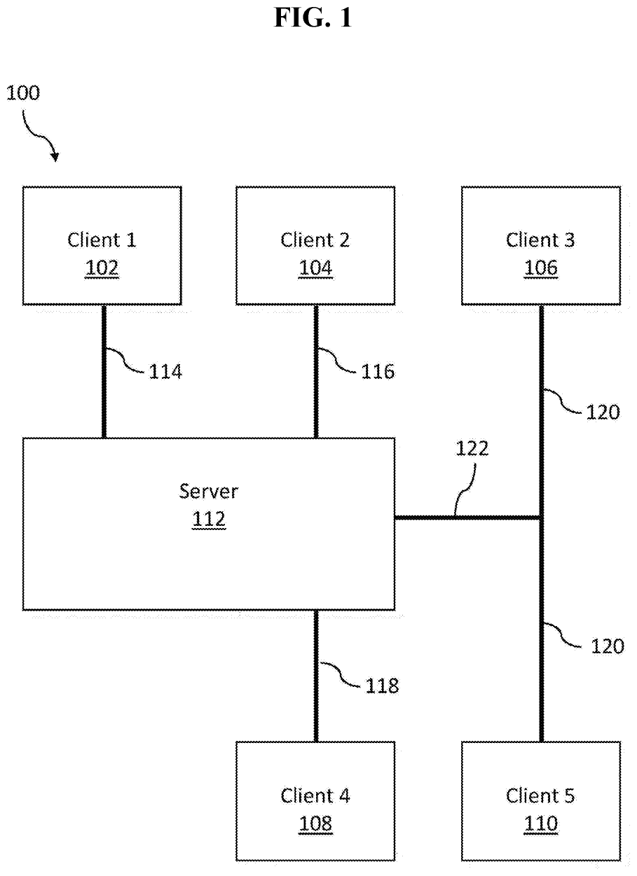

Described herein are various embodiments of methods and systems for improved computer security, authentication, and attack detection. FIG. 1 illustrates a network environment 100 that includes one or more clients 102-110 and a server 112. The clients may be personal computers, laptop computers, tablet PCs, smartphones, or any other type of end-user device, and may run MICROSOFT WINDOWS, APPLE OSX, GOOGLE ANDROID, GNU/LINUX, SYMBIAN, BLACKBERRY OS, or any other type of operating system, using executables and interpreted scripts of any common software language; including Assembly, C, C++, PERL, PHP, SQL, JAVA, JAVASCRIPT, COBOL. The clients 102-110 may communicate with the server 112 and/or each other via network links 114-122, which may be Internet links or any other wide-area or local network links, and may include ETHERNET, WI-FI, cellular networks (e.g., LTE or CDMA) or any other type of network. The clients 102-110 may allow a user to access the network via software applications, web browsers, or other software.

In one embodiment, a client 102 communicates with a server 112 via a network link 114. The server 112 may include or consist of an e-commerce web site, a banking web site, an application server, a software-as-a-service provider, a message board, or any other type of software application or server that handles or receives private information concerning the user and thus requires security or

encryption for messages therebetween. In another embodiment, a client 104 communicates with a second client 108 via the server 112, the communications may include email or similar services. In still another embodiment, a client 106 communicates directly with another client 110 via network link 120, the server 112 may or may not monitor the connection 120 passively via a connection 122. As explained below, embodiments of the present disclosure allow users of one or more of the clients 102-110 to communicate with other clients 102-110 and/or one or more servers 112 without typing his or her full username, and without transmitting his or her username or password in any of these described (or similar) configurations (e.g., client-server, server-assisted client-to-client, or direct client-to-client communication).

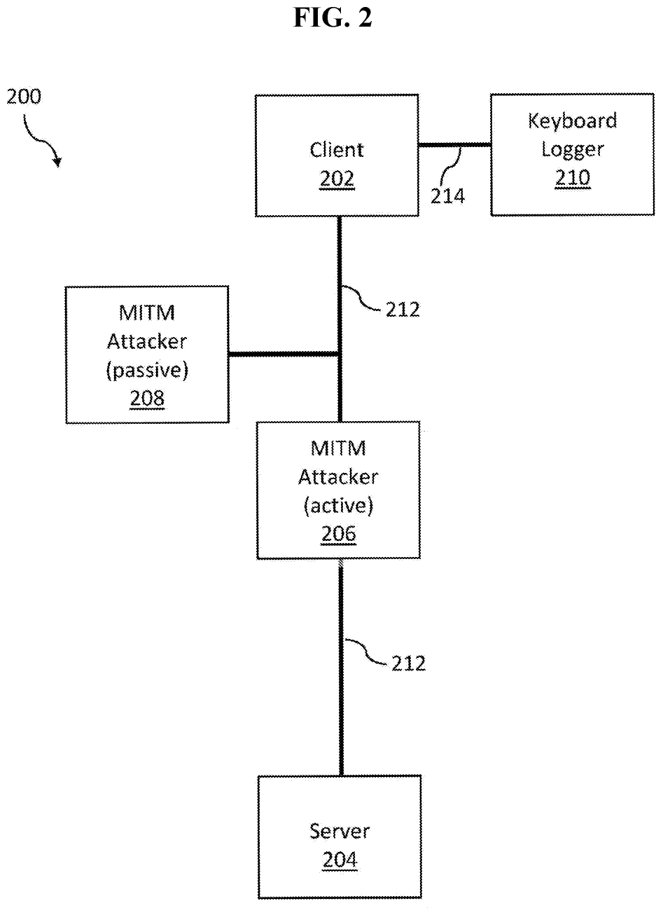

FIG. 2 illustrates a network environment 200 that includes malicious third-party attackers. A client 202 communicates with a server 204 via a network link 212. A passive man-in-the-middle (MITM) attacker 208 may monitor the communications therebetween and attempt to decrypt the communications using, in some cases, information known about the user of the client 202 (such as a Diffie-Hellman calculation or an email-address-based or other type of username). An active man-in-the-middle attacker 206 inserts itself directly in the network link 212, the attacker 206 intercepts data sent from the client 202 and/or server 204 and attempts to respond to either or both as if it were the intended recipient of the data (a so-called “oracle” attacker). Finally, a keyboard logger 210 (or similar malware) may be installed on the client 202 and/or on a device in trusted communication with the client 202 (e.g., a home router or switch or device in communication therewith) and attempt to log the user's keystrokes and/or access username or password information stored on the client computer.

I. Attack Detection

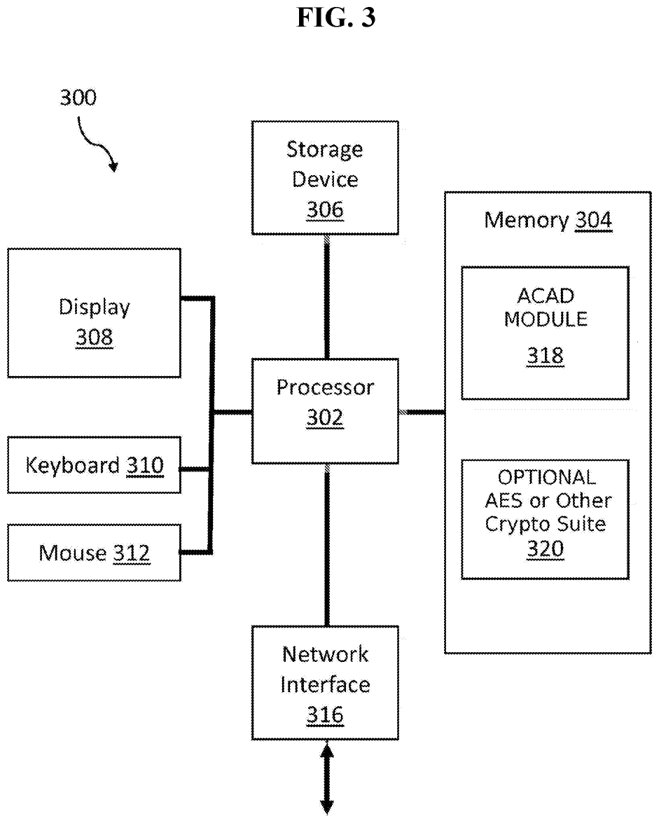

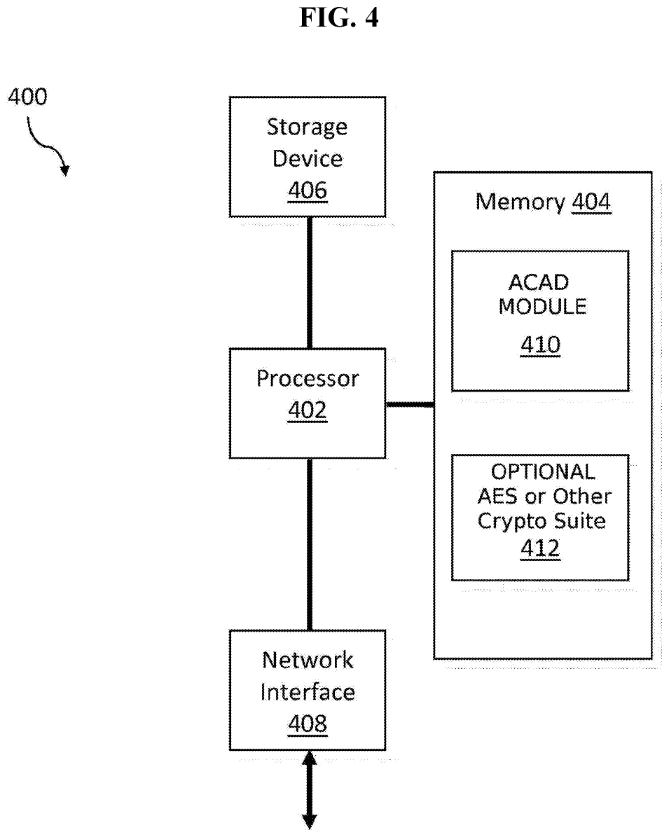

A block diagram of an example client 300 appears in FIG. 3. A processor 302 executes instructions stored in a memory 304, in one embodiment, the memory 304 includes instructions relating to an accelerated communication encrypted transmission artificial-intelligence encryption model (“ACAD”) module 318 for instructions relating to a device-authorization and attack-detection, while module 320 selects the desired encryption and key exchange protocol, depending on system specifications for authorizing the client 300 and/or detecting attacks thereon (as described in greater detail below). The memory 304 may further include instructions for executing an operating system, device drivers, other software components or applications, or any other such instructions necessary for operation of the client 300. The client 300 may also include a non-volatile storage device 306, a display 308, a keyboard 310, a mouse 312, and a network interface 316. The present disclosure is not limited, however, to any particular client architecture or collection of components. Similarly, an example server 400 is illustrated in FIG. 4 and includes a processor 402, memory 404 (including ACAD 410 and AIEM-DAAAD, AES or other cryptography suites in the 412 modules), a non-volatile storage device 406, and a network interface 408, the present disclosure is similarly not limited to the architecture or configuration of the server 400 appearing in FIG. 4, and one of ordinary skill in the art will understand that embodiments of the present disclosure apply to any clients and servers, not just those depicted in FIGS. 3 and 4.

In one embodiment of the present disclosure, with reference again to FIG. 1, a client 102 wishes to communicate securely with a server 112. In one embodiment, upon initial access to the server 112, one or more applications or application components may be downloaded from the server 112 to the client 102. The applications may include stand-alone applications written in C, C++, VISUAL BASIC, shell scripts, or any other similar language, or may be applications for use with an existing run-time environment, such as JAVA or JAVASCRIPT, which may be present on the client as part of, for example, a web browser. The number, complexity, and/or type of the applications or application components may be specified by a system administrator of the server 112 on a per-server or per-client basis. For example, different organizations may require varying levels of security, and the applications or application components may be customized accordingly (as explained in greater detail below).

The server 112 may, in addition, randomly select a subset of applications or application components from a larger pool of the same and transmit only the subset to the client 102, thereby increasing the difficultly for a malicious third party to predict which applications or application components are used by the client. Similarly, server 112 may periodically or randomly update or otherwise change the applications or application components installed on the client 102 for this same reason. Utilizing the AIEM-DAAAD methodology, the client 102 may authenticate the downloaded applications or application components as legitimately coming from the server 112 by, for example, examining the load time, number of bytes, and/or arrangement of characters therein and comparing these values to, for example, a computed checksum value, with the results of these tests forming a portion of the first key used to encrypt the client's initial reply with test results for the server to analyze.

The applications downloaded to the client 102 analyze the client 102 and/or the user operating the client 102 for one or more items of Fingerprint information. This information may include the hardware present in the client 102, such as the MAC address (or other such serial number or identifier assigned to the client 102), system type (e.g., desktop, laptop, tablet, or smartphone), processor type and/or version (e.g., INTEL PENTIUM, STRONGARM, POWERPC, etc.), firmware type and/or version, attached peripherals (e.g., RAM type or version, hard disk type and/or size, monitor size and/or resolution, etc.), and/or any other such hardware information.

The Fingerprint information may further include information regarding the software running on the client, such as operating-system type (e.g., WINDOWS, LINUX, ANDROID, or OSX), installed applications and/or their version (e.g., MICROSOFT WORD, GOOGLE CHROME, APPLE SAFARI, or other types of installed software), and/or application preferences that the user of the client 102 has set or configured (e.g., desktop-interface theme, color, and configuration, web-browser bookmarks, toolbar customization, and/or other such settings). The Fingerprint information may also include information pertaining to the user collected over time, such as keyboard typing rate, mouse movements, typical log-in/log-out or usage-session times, or other such biometric information. The Fingerprint information may be synchronized or otherwise uploaded to the server 112 such that the client 102 and server 112 include identical copies of the collected Fingerprint information. In some embodiments, the Fingerprint information includes information collected at the server 112, such as the IP address or addressing port of the client 102.

In one embodiment, during the login process, one or more of the applications or application components downloaded to the client 102 begin collecting this Fingerprint information and/or begin generating prime numbers (or similar cryptographic data). The client 102 may then begin sending, on a regular, clocked, pulsing, rapid-fire basis, as quickly as possible (e.g., 10 times or more per second), a plurality of short (e.g., single byte) packages to the server 112, the server 112 responds to each received package with a similar (e.g., single byte) response. Each package sent from the client 102 may be encrypted using information such as the last response received from the server 112 (for all but the first package sent from the client 102), the round-trip time of each package sent from the client 102 and received back from the server 112, and/or any Fingerprint information collected by the client 102. Each package sent from the client 102 may depend on one or more responses from the server 112 related to packages previously sent to the client 102. In one embodiment, each package sent from the client 102 and response received from the server 112 are used to create an increasingly larger Merkle tree chain (or similar data structure), where factors based on round-trip times, page sizes, the previous hash value and test time start and stop values create an increasingly longer and more complex key. Thus, a man-in-the-middle attacker would have to emulate the server 112 (with respect to the client 102) for each and every package sent from the client 102, as the history of the sent-and-received packages increases (e.g., the Merkle tree grows in size and complexity), it becomes increasingly more difficult for a man-in-the-middle attacker to emulate.

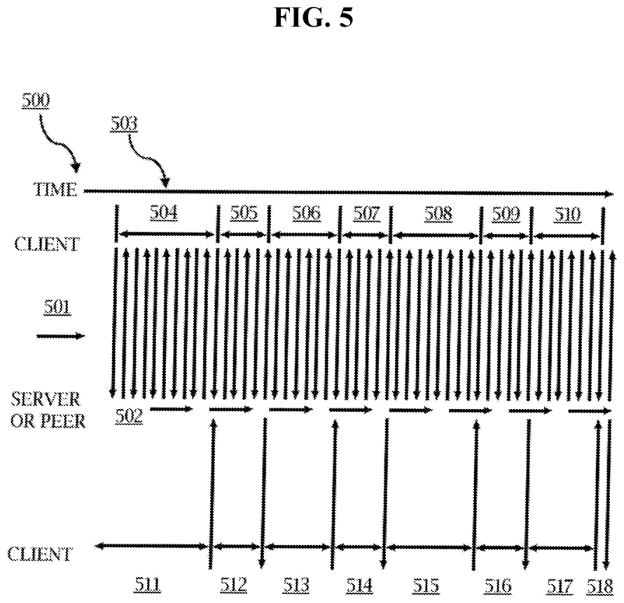

FIG. 5 illustrates an example login process, whereby FIG. 600 illustrates an example of a corrupt login process, and in both figures, a client connects to a partner (e.g., a server, another client, or any other device) via a standard protocol (e.g., TCP/IP and plain text HTTP). In response, in a second operation, Msg2, the client device receives (via, e.g., HTML and JavaScript or optionally, local script or an executable stored on the user's device), While the client and server or peer-to-peer line latency test continues at the fastest rate the transmission path and attached devices can communicate, as shown in operations 501 and 502, and the timeline shown in 503, a secondary set of transmissions begins, in operations 504 through 510 for the client, and operations 511 through 518 for the server or attached peer. The data exchanged during the secondary communication consisting of key exchanges (e.g., a Diffie-Hellman protocol), or encrypted data until the devices disconnect from each other in operation 518.

As explained in greater detail at operation 600, when any unauthorized party attempts to insert either a passive, listening device or a device performing an active attack, the line latency changes, as shown in operations 631 and 633, and with additional communications, the latency grows longer and becomes even more easily detected as shown in operations 632 and 634, though as soon as the additional latency changes the hash values of the Merkle-tree Blockchain which utilizes the time stamps by even a single digit, the keys become immediately corrupted and the session aborts. Alternatively, if the time stamps remain valid, eliminating the ability of a man-in-the-middle attacker from using a previously recorded and potentially altered Merkle-tree Blockchain to trick the client since the hashes include byte counts and other parameters measured in a rapid ongoing cycle of the AIEM QC test, the client creates the pulsed hash sent to the server from a concatenation of the client's latency monitoring events, and optionally, byte counts and hashes from page loads, device test results and test times, and the QC audit of the scripts and pages received, while the server responds with a similar hash, calculated from a hash derived from the byte count and content of the client's package and the server's response time, thereby creating a rapid, pulsed, simultaneously repeating the rapid clocked exchange of a given size set by the server administrator, embedded in script and programs and known by all parties, e.g., 1 digit per hash packet, thereby confirming the client and server in sync relating to the large, growing Merkle tree they share, creating a basis for forming a high, low, average and standard deviation table for their expected connection transit times, making it easier to detect any anomalies which may result when a man-in-the-middle is forced to complete more complex calculations in subsequent operations. In operations 504 through 518, and 604 through 634, the client and server or peer have maintained the rapid-fire exchange, while simultaneously completing all tests and begun the key exchange protocol in 511 through 514 and also in operations 611 through 614, followed by encrypted data in operations 515 through 518 and also in operations 615 through 618, whereby as illustrated in operations 631 through 634, any interference by a MITM attack creates a detectable delay or increase in the transit time between the communications between the client and the server.

Utilizing AIEM-DAAAD one-time pad technology, the login may include partial ID and Password, whereby the number of characters for which the user is prompted may be configured by the server 112. In one embodiment, a system administrator of the server 112 sets a predetermined number of characters to be entered. In other embodiments, the number of characters is dynamically set in accordance with an amount of collected Fingerprint information, if the collected Fingerprint information is relatively small (if, e.g., the Fingerprinting applications have only been recently downloaded to the client 102 and have not yet collected a sufficient amount of identifying information regarding the client 102 and/or the user of the client 102), a greater number of characters may be requested (e.g., five to ten). If, on the other hand, a relatively greater amount of Fingerprint information has been collected, fewer characters are requested (e.g., one to three).

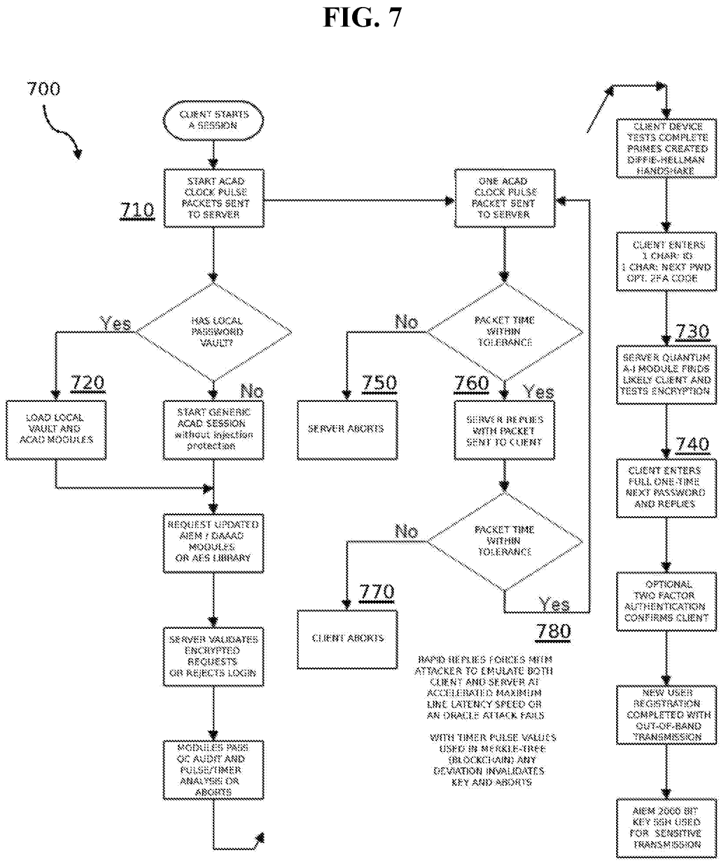

FIG. 7 illustrates a flow-chart of an example login screen that may be presented to a user of the client 102. In one embodiment, as depicted in the upper left portion of the figure, in operation 710, the user's client immediately sends a rapid sequence of pulses to the server, whereby upon receipt, the server determines if the latency since the last pulse falls within the maximum expected delay, and if not, aborts, or if acceptable, immediately replies to the client, who then also determines if the server's latency delay falls within the maximum expected delay, the entire rapid fire exchange continuing throughout the session, generating a long string of numeric values utilized in any Merkle tree Blockchain, eliminating a MITM attacker from either forging the Merkle tree, or inserting themselves in the communication in either a Passive, listening attack, or an Active attack attempting to modify keys. Any man-in-the-middle oracle attack will need to begin calculating both static and dynamic QC values to produce the same hashes, thereby producing a detected increase in latency delay.

On the right side of the FIG. 7 flow-chart, a secure AIEM-DAAAD login is depicted in the example, in this embodiment of the present disclosure, utilizing a Diffie-Hellman key exchange, as well as hashes described in the AIEM-DAAAD patent, whereby the AIEM-DAAAD system utilizes the Merkle-tree Blockchain which includes the timed pulse hashes. In other embodiments of the present disclosure, this can also be a conventional AES-256 encryption, as well as an RSA key exchange or other encryption methods, the MITM attack detection shown in 750 through 780 continuing independent of, and regardless of the encryption method utilized.

If one or more attacks have been detected in a predetermined window of time (e.g., within the last hour, day, or week) during previous or current login attempts, the degree of encryption may similarly be increases. For example, if a man-in-the-middle attacker has been detected in the past regarding the current user and/or client devices associated with the user, the server 112 may require a greater degree of encryption security. Similarly, the client 102 may perform a more rigorous “stress test” of the server, wherein the packages exchanged between the client and the server may be increased in complexity, number, and/or duration.

It will be apparent to those skilled in the art that various modifications and variations may be made in the present disclosure without departing from the technical idea or scope of the disclosure. Thus, it may be intended that embodiments of the present disclosure cover the modifications and variations of the disclosure provided they come within the scope of the appended claims and their equivalents.

What is claimed is:

1. A method for detecting an attack on a communications channel, while authenticating a user of a client device at a server or peer-to-peer or multi-peer connection, the method comprising:
monitoring the line latency, as detected by a rapid-fire exchange of a nominal number of bytes and comparing the round trip reply latency to expected values;
forming keys created by collecting information regarding the hardware, software, connection speed, or network information related to the client device or biometric information related to the user;
encrypting data, using a computer microprocessor associated with the client device, with the subset of characters of the username or password, one-time-use password, or collected information;
transmitting the encrypted data from the client device to the server via a network link therebetween; and
decrypting the data, at the server, using a server-side copy of the username, password, and collected information.

2. The method of claim 1, further comprising:
testing a transmission time between the client device and the server for a time greater than a threshold associated with normal transmission times; and
determining that a man-in-the-middle attack is occurring if the time is greater than the threshold.

3. The method of claim 1, wherein, upon receipt of the client's message created using a strong encryption key:
the server:
selects one or more potential clients from a database of clients on the server using the encrypted data received by the server, along with the encrypted data created by the client;
attempts to decrypt the client's data using a formed key, determined by the server by reproducing the key from stored parameters on the server of known clients with matching hardware, software and when available, historic connection parameters, to attempt to decrypt the client data;
if successful in indicating a matching client with similar hardware and software parameters has been found, uses the matching client's next one-time password and optional two-factor authentication, both stored on the server, to re-encrypt the client's data; and
transmits the re-encrypted data to the client;
wherein the client can only decrypt the server's re-encrypted data by entering a full password and optional two-factor authentication;
the client verifies that the re-encrypted data is the same as the encrypted data, which only an authentic server in possession of the next one-time password and optional two-factor authentication can create;
establishing a set of temporary shared keys using the hardware and software parameters and connection parameters when available, as well as the partial username, one-time password, and optional two-factor authentication;
the client uses the shared keys to encrypt and transmit to the server the first package of an encrypted algorithm exchange to establish a larger key a secure utilizing an encrypted Diffie-Hellman exchange or other secure algorithm, which is immune to a “Spoiler Attack” when the shared parameters are transmitted in an encrypted format;
if the server fails to decrypt the client's encrypted data within a short period of time or a period set by the server administrator, the client restarts the current connection and presumes that one of the following has occurred:
the current connection timed out;
the server is not authorized;
an attacker is attempting to intercept and compute the keys; or
an attacker has used an erroneous or otherwise invalid one-time password to encrypt the data;
if the client fails to decrypt the server's re-encrypted data and respond with the secure algorithm package within a short period of time or a period set by the server administrator, the server presumes that one of the following has occurred:
the connection timed out;
the user is not authorized;
an attacker created a login attempt with erroneous or otherwise invalid credentials including hardware, software, or connection parameters that do not match anything in the server's historical database; or
an attacker is attempting to compute the password, causing an unexpected extended period of delay between replies.

4. The method of claim 3, wherein, when the client fails to decrypt the server's re-encrypted data and respond with the secure algorithm package within a short period of time or a period set by the server administrator, the server:
terminates the connection, resetting all parameters;
terminates any further communication on a port if the number of consecutive failures indicates a Denial of Service attack may be in progress; or allows the client an opportunity to use a series of challenge questions to verify its identity.

5. The method of claim 1, wherein the transmitting comprises:
sending a plurality of messages from the client to the server; and
receiving, in response to each message, a response from the server to the client,
wherein at least one message sent from the client to the server includes information derived from a previously-received response from the server.

6. The method of claim 3, wherein, when the server allows the client an opportunity to use a series of challenge questions to verify their identity, the server prompts the user for an answer to a challenge question if the subset of characters in the username does not match a reference value or if the one-time-use password does not match a reference value.

7. The method of claim 3, wherein, when the client fails to decrypt the server's re-encrypted data and respond with the secure algorithm package within a short period of time or a period set by the server administrator, the server prompts the user for an answer to a challenge question if a processing ability of the client device is below a threshold.

8. The method of claim 3, wherein the creating a larger key for subsequent encryption comprises determining a strength of encrypting based on a processing ability of the client device.

9. The method of claim 1, further comprising downloading, from the server to the client device, a software application for collecting the information.

10. The method of claim 9, wherein the software application is selected from a pool of candidate software applications.

11. The method of claim 10, wherein the server periodically or randomly varies the software application downloaded to the client device.

12. The method of claim 3, further comprising prompting the user to enter a temporary two-factor authentication code.

13. The method of claim 3, further comprising:
testing a transmission time between the client device and the server for a time greater than a threshold associated with normal transmission times; and
determining that a man-in-the-middle attack is occurring if the time is greater than the threshold.

14. The method of claim 3, wherein the encrypting further comprises increasing a strength of the encrypting in response to the determined attack, or hardware or software parameters, or shared network conditions.

15. The method of c claim 3, wherein the transmitting the encrypted data comprises:
sending a plurality of messages from the client to the server; and
receiving, in response to each message, a response from the server to the client,
wherein at least one message sent from the client to the server includes information derived from a previously-received response from the server.

16. The method of claim 3, wherein, when a login fails, the client prompts the user for an answer to a challenge question if the subset of characters in the username does not match a reference value or if the one-time-use password or optional two-factor authentication does not match a reference value.

17. The method of claim 3, wherein, when a login fails, the client prompts the user for an answer to a challenge question if a processing ability of the client device is below a threshold.

18. The method of claim 3, wherein the encrypting comprises determining a strength of encrypting based on a processing ability of the client device.

19. The method of claim 1, wherein the transmitting the encrypted data comprises:
sending a plurality of messages from the client to the server; and
receiving, in response to each message, a response from the server to the client,
wherein at least one message sent from the client to the server includes information derived from a previously-received response from the server.

20. A system for authenticating a user of a client device at a server, the method comprising:
a memory configured to store information regarding the hardware, software, or network information related to the client device or biometric information related to the user;
a processor configured to execute computer instructions for:
prompting the user to enter only a subset of characters at a specific position in a username associated with the user;
prompting the user to enter only a subset of characters at a specific position in a password or a one-time-use password;
collecting information regarding the hardware, software, or network information related to the client device or biometric information related to the user;
encrypting data, using a computer microprocessor associated with the client device, with the subset of characters in the username or password, one-time-use password, or collected information;
transmitting the encrypted data from the client device to the server via a network link therebetween;
decrypting the data, at the server, using a server-side copy of the username, password, and collected information; and
when no matching server-side copy of the username, password, and collected information exists, prompting the client for a series of challenge questions or a new client registration process to establish a record on the server of client parameters.
